(19) United States
(12) Patent Application Publication
(10) Pub. No.: US 2020/0169803 A1
(43) Pub. Date: May 28, 2020

(54) HEADSET AND METHOD OF CONTROLLING HEADSET

(71) Applicant: Unlimiter MFA Co., Ltd., Eden Island (SC)

(72) Inventors: Kuo-Wei KAO, Taipei (TW); Po-Jui WU, Taipei (TW); Kai-Yuan HSIAO, Taipei (TW); Kuo-Ping YANG, Taipei (TW)

(21) Appl. No.: 16/355,934

(22) Filed: Mar. 18, 2019

(30) Foreign Application Priority Data
Nov. 22, 2018 (TW) 107141757

(51) Int. Cl. H04R 1/10; H04R 1/08

(52) U.S. Cl. CPC H04R 1/1041; H04R 1/08; H04R 1/1016

(57) ABSTRACT

A method of controlling a headset includes: obtaining a first sound received by a first microphone and obtaining a second sound received by a second microphone; via a control module, determining if a sound energy intensity difference between the first sound and the second sound is greater than an energy threshold; executing a command according to the first sound or the second sound, and a requirement of executing the command includes that the sound energy intensity difference between the first sound and the second sound is greater than the energy threshold.

### BACKGROUND OF THE INVENTION

### 1. Field of the Invention

The present invention relates to a method of controlling a headset and a headset; more particularly, the present invention relates to a method of controlling a headset and a headset which execute the control command by determining a touch on the headset case.

### 2. Description of the Related Art

There are many earphone products on the market, such as binaural earphones for listening to music or binaural hearing aids. An earphone product has a left earphone and a right earphone. The left earphone and the right earphone may have a button switch and a rotary volume adjustment unit so that the user can push the button or rotary unit with a finger to turn the earphone product on or off, or to adjust the volume level. However, the button or the rotary unit is very small in size, and the button or the rotary unit may be difficult to operate for the user.

Therefore, there is a need to provide a new method of controlling the headset such that the user can operate the earphone easily.

### SUMMARY OF THE INVENTION

It is an object of the present invention to provide a method of controlling a headset and a headset which execute the control command by determining the touch on the headset case.

To achieve the abovementioned object, the method of controlling a headset of the present invention is applied to a headset. The headset has a first microphone, a second microphone and a control module. The first microphone and the second microphone are electrically connected to the control module. The method of controlling a headset includes: obtaining a first received sound received by the first microphone, and obtaining a second received sound received by the second microphone; via the control module, determining if a sound energy intensity difference between the first received sound and the second received sound is greater than an energy threshold; according to the first received sound or the second received sound, executing at least one command, wherein at least one condition of executing the at least one command includes: the sound energy intensity difference is greater than the energy threshold.

To achieve the abovementioned object, the headset of the present invention includes a first microphone, a second microphone and a control module. The first microphone is used for receiving a first received sound. The second microphone is used for receiving a second received sound. The control module is electrically connected to the first microphone and the second microphone. The control module is used for obtaining the first received sound and the second received sound, determining if a sound energy intensity difference between the first received sound and the second received sound is greater than an energy threshold, and executing at least one command according to the first received sound or the second received sound, wherein at least one condition of executing the at least one command includes: the sound energy intensity difference is greater than the energy threshold.

### BRIEF DESCRIPTION OF THE DRAWINGS

FIG. 1 illustrates a schematic drawing of the headset in a first embodiment of the present invention.

FIG. 2 illustrates a system structure of the headset in the first embodiment of the present invention.

FIG. 3 illustrates a flowchart of the method of controlling a headset in the first embodiment of the present invention.

FIG. 4 illustrates a flowchart of the first part of the method of controlling a headset in a second embodiment of the present invention.

FIG. 4a illustrates a flowchart of the second part of the method of controlling a headset in the second embodiment of the present invention.

FIG. 5 illustrates a schematic drawing of the headset in a third embodiment of the present invention.

FIG. 6 illustrates a system structure of the headset in the third embodiment of the present invention.

FIG. 7 illustrates a flowchart of the method of controlling a headset in the third embodiment of the present invention.

### DETAILED DESCRIPTION OF THE PREFERRED EMBODIMENT

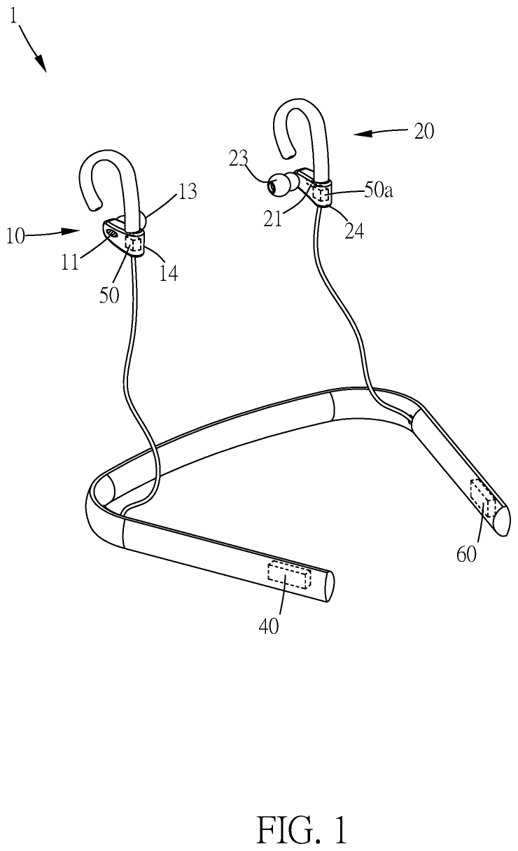

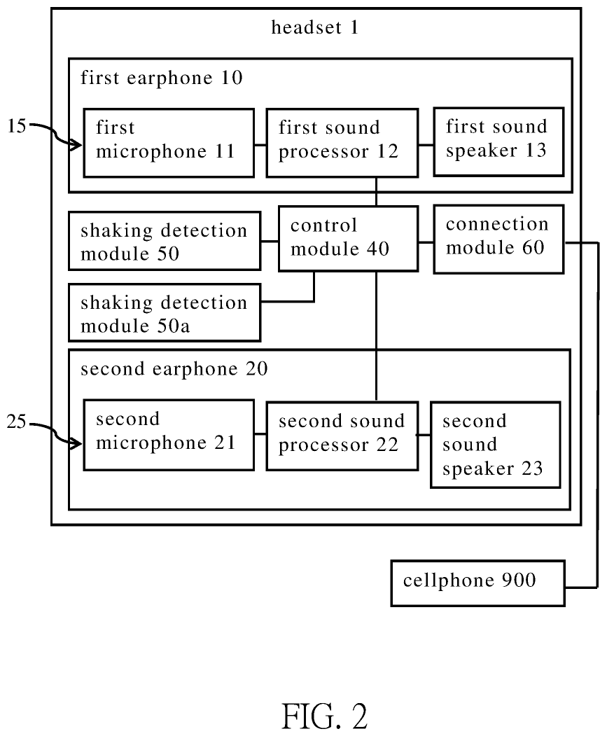

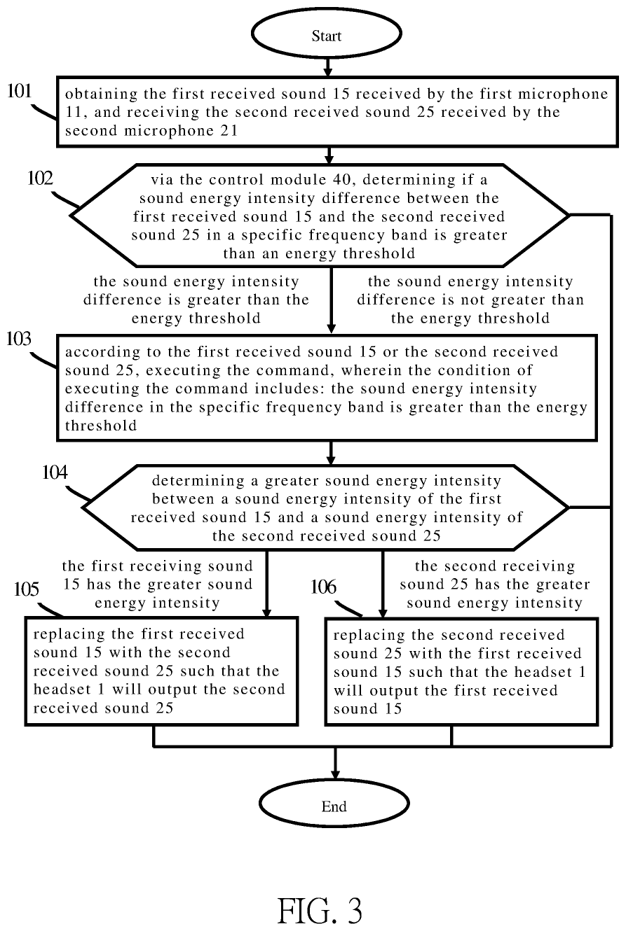

Please refer to FIG. 1 to FIG. 3, which illustrate the headset and the method of controlling a headset in the first embodiment of the present invention. FIG. 1 illustrates a schematic drawing of the headset in the first embodiment of the present invention. FIG. 2 illustrates a system structure of the headset in the first embodiment of the present invention. FIG. 3 illustrates a flowchart of the method of controlling a headset in the first embodiment of the present invention.

As shown in FIG. 1 to FIG. 3, in the first embodiment of this present invention, the method of controlling a headset is programmed as a computer program and applied to a headset 1. The method of controlling a headset is used for executing a command for controlling the headset 1 via determining a touch on the case of the headset 1, wherein the touch generates a sound; the sound generated by touching the case of the headset 1 of the present invention is the sound generated via the user's finger which touches, taps or slides on the headset 1. The headset 1 in the first embodiment is a binaural hearing aid designed for a hearing impaired person, and the headset 1 is used for receiving the surrounding sound and adjusting the surrounding sound to an enhanced sound such that the hearing impaired person can clearly hear the adjusted surrounding sound; however, the type of the headset 1 is not limited to the abovementioned description and can also be a binaural earphone for playing sound or music. The headset 1 includes a first earphone 10, a second earphone 20, a control module 40, two shaking detection modules 50, 50a and a connection module 60.

In the first embodiment of this present invention, the first earphone 10 includes a first microphone 11, a first sound processor 12, a first sound speaker 13 and a first case 14. The first microphone 11 is located on the first case 14 for receiving a first received sound 15. The first received sound 15 is an external sound generated by the external environment that the first microphone 11 is facing; however, the first received sound 15 can also be a noise generated by touching the first earphone 10 (for example, a finger touching the first earphone 10 will cause the noise). The first sound processor 12 is electrically connected to the first microphone 11, the first sound speaker 13 and the control module 40. The first sound processor 12 is located in the first case 14 and used for adjusting the first received sound 15, such as increasing the volume, changing the frequency, and reducing the noise, such that the first received sound 15 is processed into an enhanced sound that the hearing impaired person can clearly hear, or the first sound processor 12 can also turn the first earphone 10 on or off. The first sound speaker 13 is worn on the right ear of the hearing impaired person to play the adjusted sound to the right ear of the hearing impaired person.

In the first embodiment of this present invention, the second earphone 20 includes a second microphone 21, a second sound processor 22, a second sound speaker 23 and a second case 24. The second microphone 21 is located on the second case 24 for receiving a second received sound 25. The second received sound 25 is the external sound generated by the external environment that the second microphone 21 is facing; however, the second received sound 25 can also be a noise generated by touching the second earphone 20 (for example, a finger touching the second earphone 20 will cause the noise). The second sound processor 22 is electrically connected to the second microphone 21, the second sound speaker 23 and the control module 40. The second sound processor 22 is located in the second case 24 and used for adjusting the second received sound 25, such as increasing the volume, changing the frequency, and reducing the noise, such that the second received sound 25 is processed into an enhanced sound that the hearing impaired person can clearly hear, or the second sound processor 22 can also turn the second earphone 20 on or off. The second sound speaker 23 is worn on the left ear of the hearing impaired person to play the adjusted sound to the left ear of the hearing impaired person.

In the first embodiment of the present invention, the control module 40 is a chip electrically connected to the first earphone 10 and the second earphone 20. The control module 40 controls the first earphone 10 and the second earphone 20. The control module 40 is used for obtaining the first received sound 15 and the second received sound 25 to determine if a sound energy intensity difference between the first received sound 15 and the second received sound 25 in a specific frequency band is greater than an energy threshold. The control module 40 is further used for executing the command according to the first received sound 15 or the second received sound 25. The condition of executing the command includes: the sound energy intensity difference is greater than the energy threshold. The control module 40 is further used for determining a larger sound energy intensity between the sound energy intensity of the first received sound 15 and the sound energy intensity of the second received sound 25, and the control module 40 will replace the received sound having the larger sound energy intensity with the received sound having a smaller sound energy intensity such that the headset 1 will output the received sound having a smaller sound energy intensity.

The two shaking detection modules 50, 50a are motion sensors electrically connected to the control module 40. The two shaking detection modules 50, 50a are respectively located in the first case 14 and the second case 24. The two shaking detection modules 50, 50a are used for respectively detecting if the first case 14 and the second case 24 shake to further determine if the headset 1 is touched.

The connection module 60 is a wireless network module electrically connected to the control module 40, and the connection module 60 is also electrically connected to a cellphone 900 via the wireless network function, whereby the control module 40 can remotely control the cellphone 900 via the wireless network function of the connection module 60.

The computer program of the method of controlling a headset of the present invention is a firmware, which is embedded in the chip of the control module 40. When the first earphone 10 or the second earphone 20 receives the sound, the first sound processor 12 or the second sound processor 22 that receives the sound will send an electronic signal to the control module 40; at this moment, the method of controlling a headset embedded in the control module 40 will start automatically. The headset 1 executes step 101 of the method of controlling a headset: obtaining the first received sound 15 received by the is first microphone 11, and receiving the second received sound 25 received by the second microphone 21.

The control module 40 requests the first earphone 10 and the second earphone 20 to send the first received sound 15 received by the first earphone 10 and the second received sound 25 received by the second earphone 20 to the control module 40, such that the control module 40 can obtain the first received sound 15 and the second received sound 25.

Then the headset 1 executes step 102: via the control module 40, determining if a sound energy intensity difference between the first received sound 15 and the second received sound 25 in a specific frequency band is greater than an energy threshold.

The control module 40 samples the first received sound 15 and the second received sound 25 in a sampling time; thus, the sound of the analogous signal form is transformed into a discrete signal form which can easily be processed by the electronic unit. The sampling time of the present invention is between 0.02 second and 0.2 second, but the range of the sampling time is not limited to the abovementioned description.

After the control module 40 samples the sounds, the control module 40 will analyze the sound energy intensity of the first received sound 15 of the discrete signal form in the specific frequency band and the sound energy intensity of the second received sound 25 of the discrete signal form in the specific frequency hand; in the present invention, the sound energy intensities of the first received sound 15 and the second received sound 25 are the energy intensities of the sound waves, which are the amplitudes of the vibrating sound wave; the control module 40 will analyze the sound wave amplitudes of the first received sound 15 and the second received sound 25 of the discrete signal forms in the specific frequency band and ignore the sound energy intensity of the first received sound 15 and the sound energy intensity of the second received sound 25 in other frequency bands. According to the actual experiment of the applicant of this invention, the frequency range of the noise generated via touching the first earphone 10 and the second earphone 20 is less than 8,000 Hz and between 14,000 Hz and 15,000 Hz; thus, the applicant sets the ranges of the specific frequency bands to be less than 8,000 Hz and between 14,000 Hz and 15,000 Hz; a frequency outside of the specific frequency band is not a noise generated via touching the first earphone 10 and the second earphone 20, such that a frequency outside of the specific frequency band can be ignored; therefore, the sound outside of the specific frequency band in the surrounding environment will not be misjudged as a touch sound, and a precise judgment value can be obtained.

Then the control module 40 determines if the sound energy intensity difference between the first received sound 15 and the second received sound 25 is greater than the energy threshold; the energy threshold in the first embodiment is 10%, but the energy threshold value is not limited to that design and can be changed to any value between 0 and 1 according to the user requirement; the smaller the energy threshold, the easier to control the function of the headset 1 via determining the touch on the case.

If the sound energy intensity difference between the first received sound 15 and the second received sound 25 is not greater than the energy threshold, which means that the sound energy intensity of the first received sound 15 and the sound energy intensity of the second received sound 25 are close, the first earphone 10 and the second earphone 20 both receive similar environmental sounds, and neither the first earphone 10 nor the second earphone 20 is touched by an external object and thus generate no noise; thus, there is no need for the method of controlling a headset to execute the following processing. However, if the sound energy intensity difference between the first received sound 15 and the second received sound 25 is greater than the energy threshold, which means that the sound energy intensity of one of the first received sound 15 and the second received sound 25 is greater than the sound energy intensity of the other one, it also means that one of the first earphone 10 and the second earphone 20 is touched by an external object, such that the earphone which is touched will receive the noise generated by the touch.

Then the headset 1 executes step 103: according to the first received sound 15 or the second received sound 25, executing the command, wherein the condition of executing the command includes: the sound energy intensity difference in the specific frequency band is greater than the energy threshold.

Because the received sound received by the earphone which is touched has the greater sound energy intensity, then in the first embodiment, if the condition that the sound energy intensity difference in the specific frequency band is greater than the energy threshold is met, the control module 40 will execute the default command according to the received sound with the greater sound energy intensity. For example, if the sound energy intensity difference in the specific frequency band is greater than the energy threshold and the sound energy intensity of the first received sound 15 is greater than the sound energy intensity of the second received sound 25, the control module 40 can be designed to execute the command of increasing the volume to control the first sound processor 12 and the second sound processor 22 to increase the volume of the first sound speaker 13 and the second sound speaker 23 together; if the sound energy intensity difference in the specific frequency band is greater than the energy threshold and the sound energy intensity of the second received sound 25 is greater than the sound energy intensity of the first received sound 15, the control module 40 will execute the command of reducing the volume to control the first sound processor 12 and the second sound processor 22 to reduce the volume of the first sound speaker 13 and the second sound speaker 23 together, which means that the user can easily touch the first case 14 or the second case 24 to respectively generate different received sounds with different sound energy intensities such that the control module 40 will execute a command of increasing or reducing the volume.

However, the executable command or the mechanism for the control module 40 are not limited to the abovementioned design. For example, if the sound energy intensity difference in the specific frequency band is greater than the energy threshold and the sound energy intensity of the first received sound 15 is greater than the sound energy intensity of the second received sound 25, the control module 40 can be designed to execute the command of remote controlling a cellphone 900 to take a photo or video via the wireless connection function of the connection module 60; or, if the sound energy intensity difference in the specific frequency band is greater than the energy threshold, and the appearance logic of the received sound has a specific regularity (such as a Morse code), the control module 40 can also be designed to execute the corresponding command according to the meaning of the Morse code of the received sound; for example, the control module 40 can be designed to have the function of translating Morse code, such that the user can use a finger to touch the case briefly or slide on the case to express the “dot” and “dash” of Morse code, to give the command via Morse code; thus, the control module 40 can read the Morse code entered by the user to execute the corresponding command.

Because the noise generated by the finger touching on the case may be received by the headset 1, and the headset 1 will adjust the noise to be an enhanced sound and output the enhanced sound via the speaker, which could cause a hearing disturbance for the user, the headset 1 will execute the following step 104 to eliminate the noise: determining a greater sound energy intensity between a sound energy intensity of the first received sound 15 and a sound energy intensity of the second received sound 25.

The control module 40 can determine a greater sound energy intensity between the sound energy intensity of the first received sound 15 and the sound energy intensity of the second received sound 25, wherein the received sound with the greater sound energy intensity means that the earphone on the corresponding side of that received sound is touched by an external object and receives the noise. Therefore, if the control module 40 determines that the sound energy intensity of the first received sound 15 is greater than the sound energy intensity of the second received sound 25, the headset 1 will execute step 105: replacing the first received sound 15 with the second received sound 25 such that the headset 1 will output the second received sound 25.

If the control module 40 determines that the sound energy intensity of the first received sound 15 is greater than the sound energy intensity of the second received sound 25, which means that the first earphone 10 is touched by an external object and receives the noise, then the first received sound 15 is an abnormal sound with the noise and the second received sound 25 is a normal sound without the noise. Therefore, the control module 40 will send the second received sound 25 to the first sound processor 12 and control the first sound processor 12 to replace the first received sound 15 with the second received sound 25 such that the first sound speaker 13 will output the second received sound 25. Thus, the first earphone 10 and the second earphone 20 of the headset 1 of the binaural hearing aid can both output the second received sound 25 without the noise and the user will not be affected by the noise generated by the touch.

Please return to step 104; if in step 104, the control module 40 determines that the sound energy intensity of the second received sound 25 is greater than the sound energy intensity of the first received sound 15, the headset 1 will execute step 106: replacing the second received sound 25 with the first received sound 15 such that the headset 1 will output the first received sound 15.

If the control module 40 determines that the sound energy intensity of the second received sound 25 is greater than the sound energy intensity of the first received sound 15, which means that the second earphone 20 is touched by an external object and receives the noise, then the second received sound 25 is an abnormal sound with the noise and the first received is sound 15 is a normal sound without the noise. Therefore, the control module 40 will send the first received sound 15 to the second sound processor 22 and control the second sound processor 22 to replace the second received sound 25 with the first received sound 15 such that the second sound speaker 23 will output the first received sound 15; therefore, the user will not be affected by the noise generated by the touch.

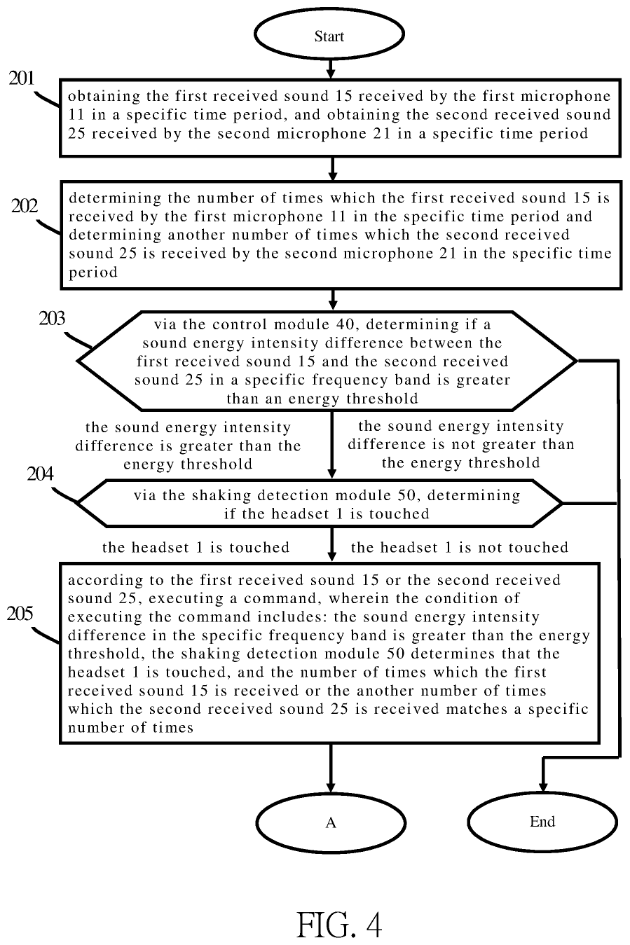

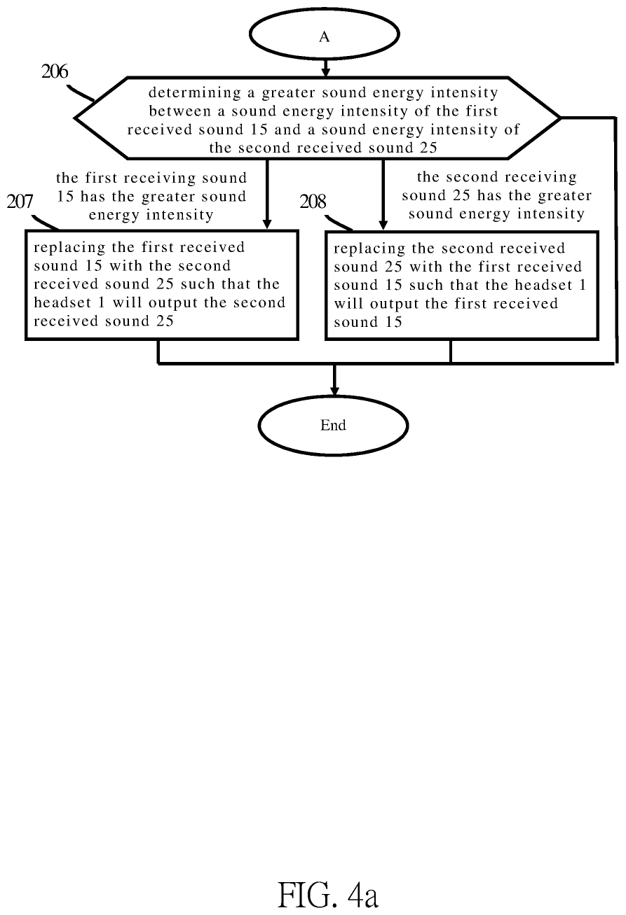

Please refer to FIG. 4 and FIG. 4a, which illustrate the method of controlling a headset in the second embodiment of the present invention. FIG. 4 illustrates a flowchart of the method of controlling a headset in the second embodiment of the present invention. FIG. 4a illustrates a flowchart of the second part of the method of controlling a headset in the second embodiment of the present invention.

As shown in FIG. 1, FIG. 2, FIG. 4 and FIG. 4a, the difference between the second embodiment and the first embodiment is that, in the method of controlling a headset of the second embodiment, the control module 40 determines the content of the command according to the number of times which the received sound is received in a specific time period, and the control module 40 also determines if the headset 1 is touched via the shaking detection modules 50, 50a to prevent the environmental sound around the headset 1 from being misjudged as a touch sound on the case.

In the second embodiment, the headset 1 executes step 201: obtaining the first received sound 15 received by the first microphone 11 in a specific time period, and obtaining the second received sound 25 received by the second microphone 21 in a specific time period.

In the second embodiment, the control module 40 requests the first earphone 10 and the second earphone 20 to send both the first received sound 15 received by the first microphone 11 in a specific time period and the second received sound 25 received by the second microphone 21 in a specific time period to the control module 40 such that the control module 40 obtains the first received sound 15 and the second received sound 25 received in the specific time period. The range of the specific time period is between 1 and 2 seconds, but the range of the specific time period is not limited to that design.

Then the headset 1 executes step 202: determining the number of times which the first received sound 15 is received by the first microphone 11 in the specific time period and determining another number of times which the second received sound 25 is received by the second microphone 21 in the specific time period.

The control module 40 determines the number of times which the first received sound 15 is received by the first microphone 11 in the specific time period and determines another number of times which the second received sound 25 is received by the second microphone 21 in the specific time period. For example, if the user's finger touches the first case 14 twice in 2 seconds, the first microphone 11 will receive the first received sound 15 twice in the specific time period of 2 seconds; thus, the control module 40 will determine that the number of times which the first received sound 15 is received is two.

Then the headset 1 executes step 203 to determine if the sound energy intensity difference between the first received sound 15 and the second received sound 25 in the specific frequency band is greater than the energy threshold; because step 203 and step 102 are the same, there is no need for further description. If the sound energy intensity difference is greater than the energy threshold, the headset 1 will execute step 204: via the shaking detection module 50, determining if the headset 1 is touched.

The two shaking detection modules 50, 50a are used for respectively detecting if the first case 14 and the second case 24 shake to further determine if the headset 1 is touched. For example, if the user's finger touches the first case 14, the shaking detection module 50 in the first case 14 will shake with the touch and the first case 14 will be determined to be touched; via this determining mechanism, the case of the headset 1 can be confirmed to be touched and thus to have been shaken and then generate the received sound to prevent the environmental sound around the headset 1 from being misjudged as a touch sound on the case.

If the shaking detection modules 50, 50a determine that the headset 1 is not touched, the headset 1 will not execute the following step. If the shaking detection modules 50, 50a determine that the headset 1 is touched, the headset 1 will execute step 205: according to the first received sound 15 or the second received sound 25, executing a command, wherein the condition of executing the command includes: the sound energy intensity difference in the specific frequency band is greater than the energy threshold, the shaking detection module 50 determines that the headset 1 is touched, and the number of times which the first received sound 15 is received or the another number of times which the second received sound 25 is received matches a specific number of times.

If the conditions that the sound energy intensity difference in the specific frequency band is greater than the energy threshold, that the shaking detection module 50 determines that the headset 1 has been touched, and that the number of times which the first received sound 15 is received or the another number of times which the second received sound 25 is received matches a specific number of times are all met, the control module 40 will execute the default command according to the received sound with the greater sound energy intensity and the number of occurrences of the received sound. For example, if the sound energy intensity difference in the specific frequency band is greater than the energy threshold, the shaking detection module 50 determines that the headset 1 is touched, that the sound energy intensity of the first received sound 15 is greater than the sound energy intensity of the is second received sound 25, and that the number of times which the first received sound 15 is received matches a specific number of times (such as twice), the control module 40 will control the first sound processor 12 and the second sound processor 22 to shut down, which means that the user can give different commands via touching the case several times. Furthermore, the limitation by the command executing mechanism of the control module 40 of the number of times which the first received sound 15 is received and the second received sound 25 is received within a specific time period can further prevent the user from accidentally knocking the case and inadvertently giving the command.

Then the headset 1 executes the following step 206 to step 208 to eliminate the noise; because step 206 to step 208 in the second embodiment and step 104 to step 106 for eliminating the noise in the first embodiment are the same, there is no need for further description.

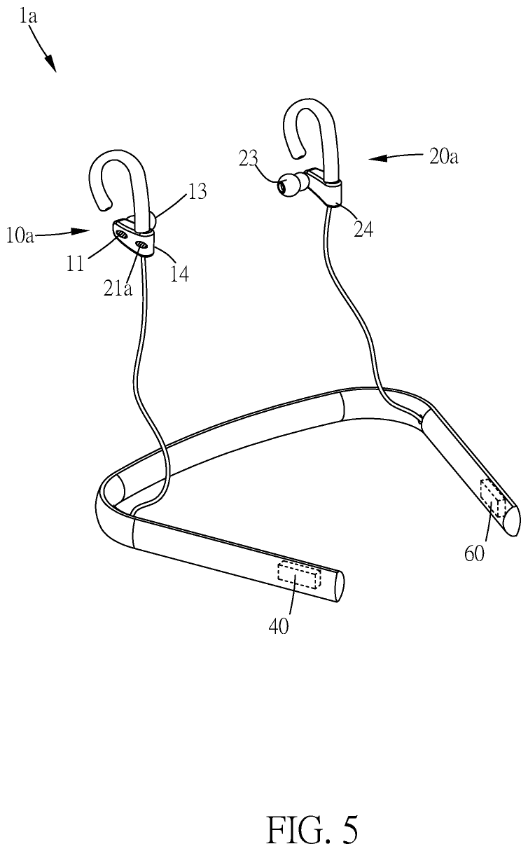

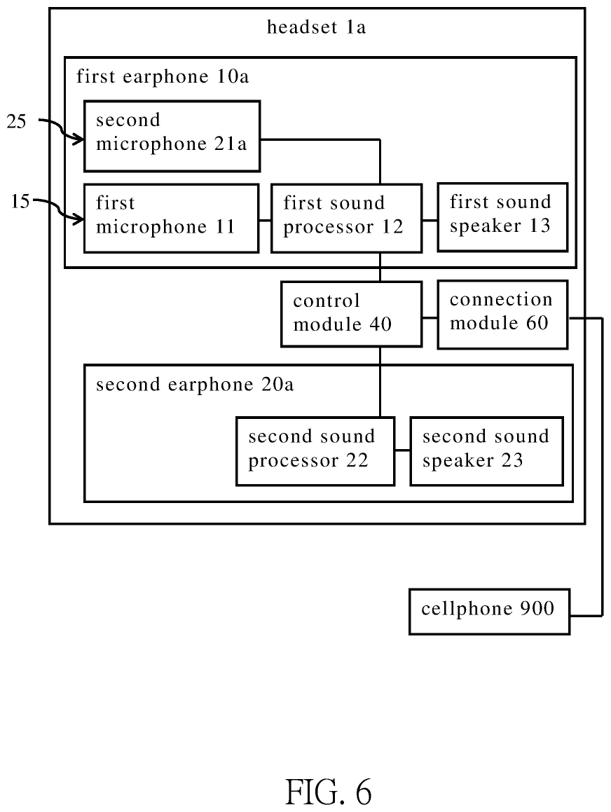

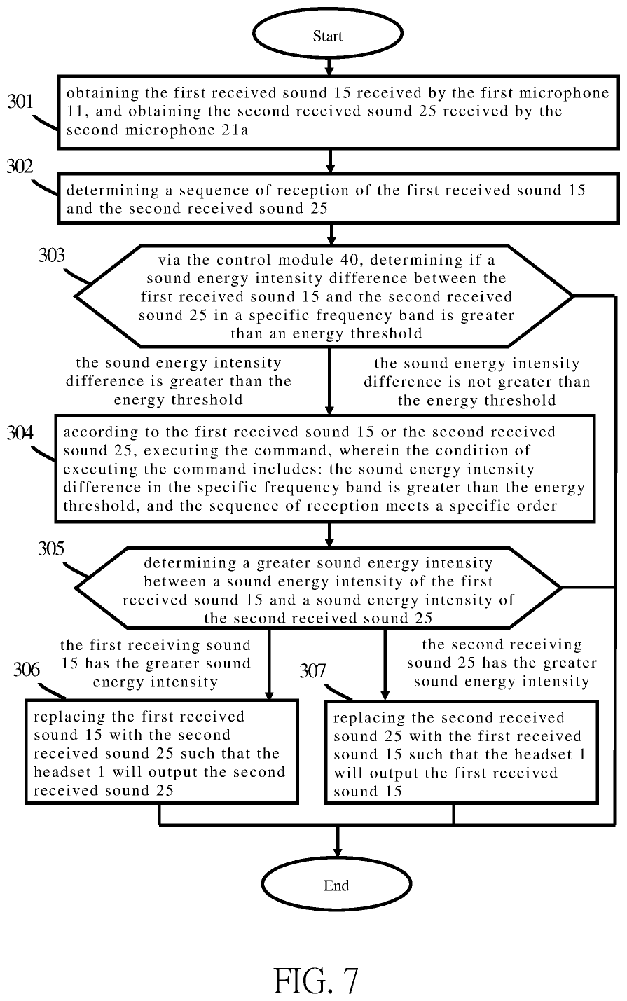

Please refer to FIG. 5 to FIG. 7A which illustrate the method of controlling a headset in the third embodiment of the present invention. FIG. 5 illustrates a schematic drawing of the headset in the third embodiment of the present invention. FIG. 6 illustrates a system structure of the headset in the third embodiment of the present invention. FIG. 7 illustrates a flowchart of the method of controlling a headset in the third embodiment of the present invention.

As shown in FIG. 5 to FIG. 7, the difference between the third embodiment and the first embodiment is that the headset 1a in the third embodiment does not include shaking detection modules, the second earphone 20a of the headset 1a does not include a microphone, and the first earphone 10a further includes a second microphone 21a. The first microphone 11 and the second microphone 21a of the first earphone 10a are both located on the first case 14. When the user's finger slides between the first microphone 11 and the second microphone 21a, a time difference of the sequence of reception of the first received sound 15 and the second received sound 25 is generated; therefore, the control module 40 can determine the content of the command according to the sequence of reception difference in the second embodiment.

In the third embodiment, the headset 1a executes step 301: obtaining the first received sound 15 received by the first microphone 11, and obtaining the second received sound 25 received by the second microphone 21a.

In the third embodiment, the control module 40 requests the first earphone 10a and the second earphone 20a to send both the first received sound 15 received by the first microphone 11 and the second received sound 25 received by the second microphone 21a to the control module 40. Because the first microphone 11 and the second microphone 21a are both located on the first case 14, if the user's finger slides between the first microphone 11 and the second microphone 21a, there will be a sequence of reception of the received sound received by the first microphone 11 and the received sound received by the second microphone 21a; for example, the user's finger can touch the first microphone 11 and then slide to the second microphone 21a; thus, the first microphone 11 will receive the first received sound 15 first, and then the second microphone 21a will receive the sliding sound of the second received sound 25.

Then the headset 1a executes step 302: determining a sequence of reception of the first received sound 1.5 and the second received sound 25.

The control module 40 determines the sequence of reception of the first received sound 15 and the second received sound 25. For example, if in step 301, the first microphone 11 receives the first received sound 15 before the second microphone 21a receives the second received sound 25, then the control module 40 can determine that the sequence of reception is: “receiving the first received sound 15 first, then receiving the second received sound 25”. However, if the user touches only one microphone (such as only touching the first microphone 11) and does not touch another microphone, then the control module 40 can determine that the sequence of reception is: “only receiving the first received sound 15”.

Then the headset 1a executes step 303; because step 303 in the third embodiment and step 102 in the first embodiment are the same, there is no need for further description. Then the headset 1a executes step 304: according to the first received sound 15 or the second received sound 25, executing the command, wherein the condition of executing the command includes: the sound energy intensity difference in the specific frequency band is greater than the energy threshold, and the sequence of reception meets a specific order.

If the conditions that the sound energy intensity difference in the specific frequency band is greater than the energy threshold and that the sequence of reception meets the specific order are met, the control module 40 will execute the default command according to the received sound with the greater sound energy intensity and the sequence of reception of the received sounds. For example, if the sound energy intensity difference in the specific frequency band is greater than the energy threshold, the headset 1a receives the first received sound 15 and the second received sound 25, and the sequence of reception meets a specific order (such as “receiving the first received sound 15 first, then receiving the second received sound 25”), the control module 40 will control the first sound processor 12 and the second sound processor 22 to enhance the low frequency of the sound; or, if the sound energy intensity difference in the specific frequency band is greater than the energy threshold, only the second microphone 21.a receives the second received sound 25, and the sequence of reception meets another specific order (such as “only receiving the second received sound 25”), the control module 40 will control the first sound processor 12 and the second sound processor 22 to enhance the high frequency of the sound.

Then the headset 1a executes the following step 305 to step 307 to eliminate the noise; because step 305 to step 307 in the third embodiment and step 104 to step 106 in the first embodiment to eliminate the noise are the same, there is no need for further description. It is to be known that, although the second earphone 20a in the third embodiment does not include a microphone, the second earphone 20a can changed to include two microphones according to user requirements; therefore, the user can touch the two microphones of the second earphone 20a or slide between the two microphones to cause the control module 40 to execute more commands.

Via the method of controlling a headset and the headset of the present invention, the user can easily touch the case of the earphone to cause the different microphones to receive different received sounds or generate different numbers of times the sounds are received or sequences of reception such that the headset can execute different commands according to different received sounds and different numbers of times sounds are received or sequences of reception, allowing the user to operate the headset easily.

What is claimed is:

1. A method of controlling headset, applied to a headset, wherein the headset comprises a first microphone, a second microphone and a control module, and the first microphone and the second microphone are electrically connected to the control module, the method of controlling headset comprising:
obtaining a first received sound received by the first microphone, and obtaining a second received sound received by the second microphone;
via the control module, determining if a sound energy intensity difference between the first received sound and the second received sound is greater than an energy threshold; and
according to the first received sound or the second received sound, executing at least one command, wherein at least one condition of executing the at least one command comprises: the sound energy intensity difference is greater than the energy threshold.

2. The method of controlling headset as claimed in claim 1, further comprising:
determining a greater sound energy intensity between a sound energy intensity of the first received sound and a sound energy intensity of the second received sound;
if the sound energy intensity of the first received sound is greater than the sound energy intensity of the second received sound, replacing the first received sound with the second received sound such that the headset will output the second received sound; and
if the sound energy intensity of the second received sound is greater than the sound energy intensity of the first received sound, replacing the second received sound with the first received sound such that the headset will output the first received sound.

3. The method of controlling headset as claimed in claim 1, further comprising:
determining a sequence of reception of the first received sound and the second received sound.

4. The method of controlling headset as claimed in claim 3, wherein the condition of executing the at least one command further comprises: the sequence of reception meets a specific order.

5. The method of controlling headset as claimed in claim 1, wherein the step of obtaining a first received sound received by the first microphone and obtaining a second received sound received by the second microphone further comprises:
obtaining the first received sound received by the first microphone in a specific time period, and obtaining the second received sound received by the second microphone in the specific time period.

6. The method of controlling headset as claimed in claim 5, further comprising:
determining a number of times which the first received sound is received by the first microphone in the specific time period, and another number of times which the second received sound is received by the second microphone in the specific time period.

7. The method of controlling headset as claimed in claim 6, wherein the condition of executing the at least one command further comprises: the number of occurrences of the first received sound or the another number of occurrences of the second received sound is a specific number of times.

8. The method of controlling headset as claimed in claim 1, wherein the headset further comprises at least one shaking detection module, the at least one shaking detection module being electrically connected to the control module;
the method of controlling a headset further comprises: via the at least one shaking detection module, determining if the headset is touched;
the condition of executing the at least one command further comprises: the at least one shaking detection module determines that the headset is touched.

9. The method of controlling headset as claimed in claim 1, wherein the step of determining via the control module if the sound energy intensity difference between the first received sound and the second received sound is greater than the energy threshold further comprises:
determining if the sound energy intensity difference between the first received sound and the second received sound in a specific frequency band is greater than the energy threshold;
the condition of executing the at least one command further comprises: the sound energy intensity difference in the specific frequency band is greater than the energy threshold.

10. The method of controlling headset as claimed in claim 3, further comprising:
determining a greater sound energy intensity between a sound energy intensity of the first received sound and a sound energy intensity of the second received sound;
if the sound energy intensity of the first received sound is greater than the sound energy intensity of the second received sound, replacing the first received sound with the second received sound such that the headset will output the second received sound; and
if the sound energy intensity of the second received sound is greater than the sound energy intensity of the first received sound, replacing the second received sound with the first received sound such that the headset will output the first received sound.

11. A headset, comprising:
a first microphone, used for receiving a first received sound;
a second microphone, used for receiving a second received sound; and
a control module, electrically connected to the first microphone and the second microphone, wherein the control module is used for obtaining the first received sound and the second received sound, determining if a sound energy intensity difference between the first received sound and the second received sound is greater than an energy threshold, and executing at least one command according to the first received sound or the second received sound, wherein at least one condition of executing the at least one command comprises: the sound energy intensity difference is greater than the energy threshold.

12. The headset as claimed in claim 11, wherein the control module is further used for determining a greater sound energy intensity between a sound energy intensity of the first received sound and a sound energy intensity of the second received sound; if the sound energy intensity of the first received sound is greater than the sound energy intensity of the second received sound, replacing the first received sound with the second received sound such that the headset will output the second received sound; if the sound energy intensity of the second received sound is greater than the sound energy intensity of the first received sound, replacing the second received sound with the first received sound such that the headset will output the first received sound.

13. The headset as claimed in claim 11, wherein the control module is further used for determining a sequence of reception of the first received sound and the second received sound.

14. The headset as claimed in claim 13, wherein the condition of executing the at least one command further comprises: the sequence of reception meets a specific order.

15. The headset as claimed in claim 11, wherein the control module is further used for obtaining the first received sound received by the first microphone in a specific time period, and for obtaining the second received sound received by the second microphone in the specific time period.

16. The headset as claimed in claim 15, wherein the control module is further used for determining a number of times which the first received sound is received by the first microphone in the specific time period, and another number of times which the second received sound is received by the second microphone in the specific time period.

17. The headset as claimed in claim 16, wherein the condition of executing the at least one command further comprises: the number of occurrences of the first received sound or the another number of occurrences of the second received sound is a specific number of times.

18. The headset as claimed in claim 11, wherein the headset further comprises at least one shaking detection module, and the at least one shaking detection module is electrically connected to the control module; the control module is further used for determining if the headset is touched via the at least one shaking detection module; the condition of executing the at least one command further comprises: the at least one shaking detection module determines that the headset is touched.

19. The headset as claimed in claim 11, wherein the control module is further used for determining if the sound energy intensity difference between the first received sound and the second received sound in a specific frequency band is greater than the energy threshold; the condition of executing the at least one command further comprises: the sound energy intensity difference in the specific frequency band is greater than the energy threshold.

20. The headset as claimed in claim 13, wherein the control module is further used for determining a greater sound energy intensity between a sound energy intensity of the first received sound and a sound energy intensity of the second received sound; if the sound energy intensity of the first received sound is greater than the sound energy intensity of the second received sound, replacing the first received sound with the second received sound such that the headset will output the second received sound; if the sound energy intensity of the second received sound is greater than the sound energy intensity of the first received sound, replacing the second received sound with the first received sound such that the headset will output the first received sound.
